(19) United States
(12) Patent Application Publication
(10) Pub. No.: US 2010/0175015 A1
(43) Pub. Date: Jul. 8, 2010

(54) System And A Computer Implemented Method For Automatically Displaying Process Information In An Industrial Control System

(76) Inventors: Jan Lagnelov, Vasteras (SE); Thomas Pauly, Vasteras (SE)

Correspondence Address: ST. ONGE STEWARD JOHNSTON & REENS, LLC, 986 BEDFORD STREET, STAMFORD, CT, 06905-5619, US

(21) Appl. No.: 12/721,194

(22) Filed: Mar. 10, 2010

Related U.S. Application Data
(63) Continuation of application No. PCT/EP2008/061663, filed on Sep. 4, 2008.

(30) Foreign Application Priority Data
Sep. 11, 2007 (SE) 0702033-2

(51) Int. Cl. G06F 3/048

(52) U.S. Cl. 715/771

(57) ABSTRACT

A method and system for displaying process information in an industrial control system including generating at least one trend curve A-D for one or more variables of a process for a given time interval 9. An event log including process events is made and a list of events is also generated. For a selected variable at least one visible marker 1, 2 is automatically placed on the trend curve A of a process information display 100 providing access to at least one event which has been selected as related to the variable that the trend curve represents.

### CROSS-REFERENCE TO RELATED APPLICATIONS

The present application is a continuation of pending International patent application PCT/EP2008/061663 filed on Sep. 4, 2008 which designates the United States and claims priority from Swedish patent application 0702033-2 filed on Sep. 11, 2007, the content of which is incorporated herein by reference.

### FIELD OF THE INVENTION

The present invention is concerned with a computer implemented method for displaying process information in an industrial control system. In particular it concerns automatically displaying information about events in a process control system.

### BACKGROUND OF THE INVENTION

Computer controlled systems for monitoring and/or controlling manufacturing processes in chemical, pharmaceutical, food, metal, mines, and pulp and paper industries are well known. Other examples of industries and utilities where control systems are used are automotive, steel mills etc., consumer products, power generation, power distribution, pure and waste water handling, oil refineries, gas pipe-lines and off-shore platforms.

FIG. 5 illustrates an example of a typical computer based control system. It consists of controllers, servers and workstations connected to a local area network. Servers are computers that include software that provides various forms of system functionality. Workstations are computers that include software that provides various forms of user interaction. Controllers are computers that include software that performs the actual control functions. To the controllers, sensors and actuators are connected for measuring and affecting various forms of process variables, such as temperature, flow, pressure, level, position, on/off position etc. Variations of this basic structure are of course possible. For example, server and workstation functionality may reside in the same computer, or server and control functionality, or any other combination.

Besides functions for controlling a process, control systems normally also include monitoring or supervisory functions, including functions for generating events dependent on various conditions related to the controlled and supervised process. Other sources of events include software applications such as applications for condition monitoring, optimization, calculations etc. Events are stored in one or more event logs for later retrieval for presentation to users as event lists, and for various other functions such as analysis of courses of events, etc. Events may also be used to generate alarms.

Control systems typically also include functions for collecting and storing historical data. Historical data are series of values representing the development of process variables over time. Other sources of historical data include software applications such as applications for condition monitoring, optimization, calculations etc. Historical data are stored for later retrieval for presentation to users as trend charts or in other forms, and for further processing by other applications, such as for analyzing or optimizing the controlled process. A trend chart is a chart with one or more curves, each curve showing the historical development of one variable as a function of time.

Trend chart presentation and event lists are separate functions. However, when an operator or other user wishes to investigate data values in a trend chart he/she may also have to search through an event list to find one or more events or alarms that may be relevant or related in some way to the process data of interest in the trend chart. When an operator or an engineer or other user is studying a process situation or a problem such as a process upset, plant trip, or other anomaly, they typically study the trend curves and event lists. A trend curve shows a plot or graph of a process variable. An event list contains a list of reported alarms and other events. Event lists are normally dynamic, containing the last 1000 or 5000 events or more, and changing all the time as events occur in one or more processes.

U.S. Pat. No. 7,023,440 entitled Methods and apparatus for integrated display of process events and trend data, assigned to Fisher Rosemount, describes a workstation that generates and displays a trend chart that represents values of one or more selected process variables during a selected time window. The workstation also generates and displays an event table containing information describing all process events related to the selected process variables that occurred during the selected time window. The display of trend charts combined on the same overall display screen with an event table presents an improved display of information. However the operator still has to study one or more trend curves and search in the event table for likely or specific events that may, or may not, be linked to the trend chart data of interest. All events reported in a plant for the selected time window are displayed, but these events are limited to the events included in a current list of alarms.

### SUMMARY OF THE INVENTION

According to an aspect of the present invention an improvement is described of a method for providing a user interface for an industrial control system controlling one or more processes wherein the user interface is arranged for generating a trend curve for one or more variables of a process during a given time interval, wherein the method further comprises generating at least one visible marker placed on the trend curve of a process information display and which marker represents at least one event which is related to a variable that the trend curve represents.

In an embodiment of the invention an improvement is described of a method for providing a user interface for an industrial control system controlling one or more processes wherein the user interface is arranged for generating a trend curve for one or more variables of a process and where the method further comprises generating at least one visible marker placed on the trend curve of a process information display wherein the user interface is further arranged for providing a display function associated with the at least one visible marker, which display function is activated when a user moves a visible pointer, mouse pointer, hand or other indicator on the process information display on to, or close to, the visible marker placed on the trend curve. The advantage of this embodiment is that an operator may point to the marker, either using a graphic computer input device such as a mouse pointer operating within the graphic display, or using a hand or pointer with a touch screen or similar to physically point to the marker displayed by display screen, thus using the minimum of effort and computer system resources to interrogate the event that is reported. The report is only displayed as long as the mouse pointer or other input means is pointed at or held near the marker. Thus information about an event, information predetermined to be related to the trend, may be examined by an operator without having to actively select or click to open a link or window which then has to be clicked to close it or return from. Reduced effort and reduced visual clutter of open windows, boxes etc on the display.

In an embodiment of the invention an improvement is described of a method for providing a user interface for an industrial control system controlling one or more processes wherein the user interface is arranged for generating a trend curve for one or more variables of a process and where the method further comprises generating at least one visible marker placed on the trend curve of a process information display wherein the user interface is further arranged for generating the visible marker on the trend curve at the time of the event related to the variable that the trend curve represents. An advantage of this embodiment is that an operator may examine first events within the time window selected and shown on the display of the trend curve on which the marker is visible before searching through events occurring at other times.

In another embodiment of the invention an improvement is described of a method for providing a user interface for an industrial control system controlling one or more processes wherein the user interface is arranged for generating a trend curve for one or more variables of a process and where the method further comprises generating at least one visible marker placed on the trend curve of a process information display wherein the user interface is arranged for calculating which event or events are related to the variable that the trend curve represents and generating the visible marker on the trend curve at the time of the one or more events.

In an embodiment of the invention an improvement is described of a method for providing a user interface for an industrial control system controlling one or more processes wherein the user interface is arranged for generating a trend curve for one or more variables of a process and where the method further comprises generating at least one visible marker placed on the trend curve of a process information display wherein the user interface is arranged for calculating which event or events are related to the variable dependent based in part on a look-up function to identify events configured to be related to a selected variable.

In another embodiment of the invention an improvement is described of a method for providing a user interface for an industrial control system controlling one or more processes wherein the user interface is arranged for generating a trend curve for one or more variables of a process and where the method further comprises generating at least one visible marker placed on the trend curve of a process information display wherein the user interface is arranged for calculating which event or events are related to the variable dependent based in part on an automated cause-and-effect analysis.

In another embodiment of the invention an improvement is described of a method for providing a user interface for an industrial control system controlling one or more processes wherein the user interface is arranged for generating a trend curve for one or more variables of a process and where the method further comprises generating at least one visible marker placed on the trend curve of a process information display wherein the user interface is further arranged for calculating which event or events are related to the variable dependent based in part on experience information provided by operators after earlier occurrences.

Process control systems typically include functions for storing historical data and presenting them in trend charts, and for storing event data and presenting them in event lists. Trend chart presentation and event lists are separate functions. However known systems have not provided an effective way to relate event data to trend curves and this must instead be done manually by skilled and experienced users.

The trend chart presentation in a system for process automation according to an aspect of the invention is amended and improved by adding a visible indicator or marker of one or more related events, and preferably also by the use of a display of event information in the form of a tool-tip display. The information displayed by the trend chart is amended with one or more markers on the trend curves, representing one or more events and comprising information about the one or more events related to the variable represented by each curve. Different markers may be used to show different types of events, by for example being of varying shape and/or color. When the user selects such a marker by, for example, moving a computer mouse or other input device so that an on-screen pointer hovers above such a marker, a “tool-tip” type of display pops up, showing the technical details of the data or other information logged for the event. When the user selects or actively clicks on the marker, additional related information is calculated and/or retrieved, and displayed. Selection of the marker may also or instead be activated in other ways, such as via a keyboard key combination, or a selection method for another computer input device.

This additional related information can for example be other related events, such as the first event (or alarm) in a group of related events (or alarms), or more detailed information about the event or signal, or a link to an event or alarm list, etc. What events are related can be preconfigured in the control system, or be determined by a separate application, which for example determines cause and effect, first up, or similar relations, or uses experience-based information that operators have provided on earlier occurrences.

In another aspect of the invention an industrial control system controlling one or more processes is described which system comprises a computer, a memory storage device, and a process information display device and a computer program for generating a trend curve for one or more variables of one of the one or more processes during a given time interval, which system further comprises a software and/or hardware device means for generating at least one visible marker placed on the trend curve and providing access to at least one event which is related to the variable that the trend curve represents.

The advantages of the improved system and methods include that the operator or other user is automatically provided with information about events which are relevant to the trend curve of interest, and provided with access to additional information about such events, without the user having to search through a list of all of the current events or alarms in the plant and deduce from his or her own process experience or own knowledge which events may be related to one or more trend curves. Another advantage is that the invention provides direct access to existing event information that is related to the variable shown by a trend curve. The advantage of reducing or eliminating the searching of event lists to understand a process trend curve is that the process control system automatically provides relevant information more quickly in a problem situation. This is a very important advantage because time available to take action to correct a problem or variable outside of a range may be very short. In hazardous or emergency situations the amount of time available is of course extremely important, giving the user an improved opportunity to take corrective action. In normal use, the improved access to information about an event related to the trend curve also has the advantage of reducing operator fatigue, as the amount of searching back and forth in event and alarm lists to find relevant information is greatly reduced and in some cases largely eliminated. This is an advantage when an operator or an engineer is carrying out tasks on a process such as: determining a status of the process, determining a status of a process variable, tuning a process, handling an alarm, closing an alarm, identifying a first event in a series of events, analyzing or determining the cause for a process upset, analyzing or determining the cause for a deviation from normal or intended development of a process, etc.

In a further embodiment the event information made accessible may comprise information about related alarms, such as first alarm of a series of related alarms or events.

In a preferred embodiment of the invention the computers or servers or microprocessors of the process control system comprise one or more memory storage devices for storing one or more computer programs that carry out the methods according to an aspect of the invention. Preferably such computer programs comprise instructions for the computers or processors to perform the method as mentioned above and described in more detail below. In one embodiment the computer program or programs are provided on a computer readable medium or data carrier.

### BRIEF DESCRIPTION OF THE DRAWINGS

Embodiments of the invention will now be described, by way of example only, with particular reference to the accompanying drawings in which:

FIG. 1 is a schematic diagram or screen shot showing a display of a process control system for an industrial installation according to an embodiment of the invention;

FIG. 2 is a schematic diagram or screen shot showing a display of a process control system according to an embodiment of the invention;

FIG. 3 is a similar schematic or screen shot showing a display of a process control system;

FIG. 4, Prior Art, is a schematic block diagram of a known display of an event list and a trend chart combined on the same display according to the prior art;

FIG. 5, Prior Art, is a simplified schematic diagram of a known process control system;

FIGS. 6a, 6b are flowcharts for a method for generating a visible marker placed on the trend curve of a process information display according to an embodiment of the invention.

### DETAILED DESCRIPTION OF THE INVENTION

A user such as an operator, engineer or technician in a factory or other installation for industrial or commercial operations wishes to retrieve and/or manipulate information about an industrial device. The user may have already activated one or more control programs of an industrial control system so as to display a part of the installation including the industrial device of interest.

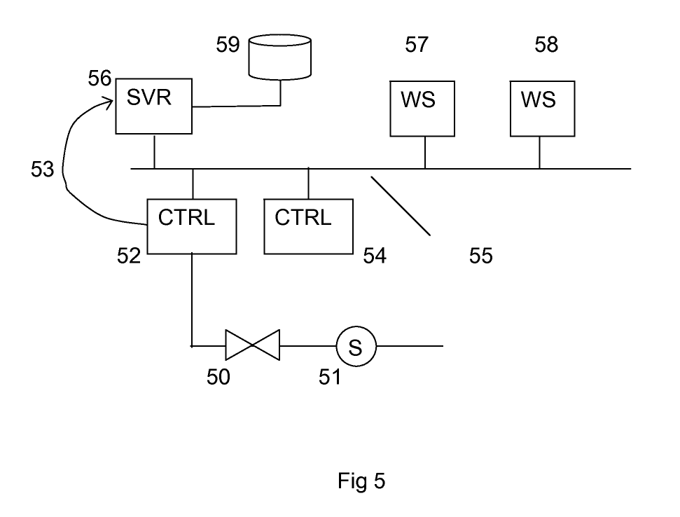

In order to explain the features of the invention a layout for a known system, FIG. 5 Prior Art, shows a simplified diagram for a part of an industrial control system. The figure shows a valve 50 and a sensor 51, and controllers 52, 54. A control network 55 or other data network is shown, and two operator computers or workstations 57, 58. A data server 56 is shown and a database 59 for logging events and historical data. Such a layout for a part of a control system is known.

At the device level, the field device or other device such as valve 50 is controlled by a controller 52, which is connected, e.g. via control network 55, to an industrial control system or process system. Sensor 51 measures a process variable for this part of the process section and generates a signal of some kind. The signal is sent to the control system, where the process variable is stored in memory. When a variable has been configured for event logging then certain events occurring that involve the selected variable are sent 53 by a controller 52 to a data logging server, where it is stored in an event log for later retrieval. Similarly when a variable has been configured for history logging, values are sampled by a controller at certain time intervals, and then sent to a data logging server where they are stored in a history log. Events and history logs for a process section such as this one may be monitored from a workstation such as workstations 57 or 58. Other arrangements are possible. For example, the event and or history logs may reside in the controller, or in a workstation.

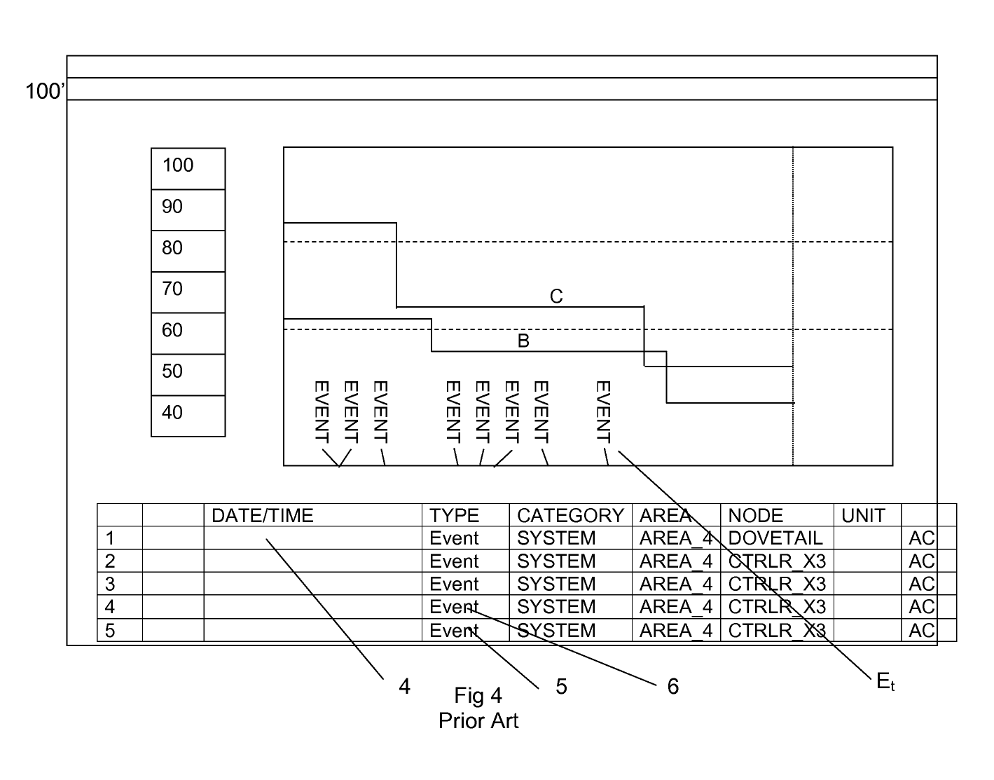

In order to explain the features of the invention, certain features of FIG. 4 (Prior Art) will next be described. FIG. 4 shows a screen display 100′ for a known operator workstation, or similar, for a process control system. The presentation shows two trends B, C, or trend lines, in a diagram in which time increases from left to right. The presentation screen also includes an event table 4 which presents a list of events 5, 6. During the time period for which trends C, B are displayed a number of events have occurred in the process, and the time at which they occurred is indicated by placing the word EVENT shown lettered in a vertical direction at the bottom of the trend chart, see reference Eₜ in FIG. 4. The events are presented in the event list and at time of event occurrence.

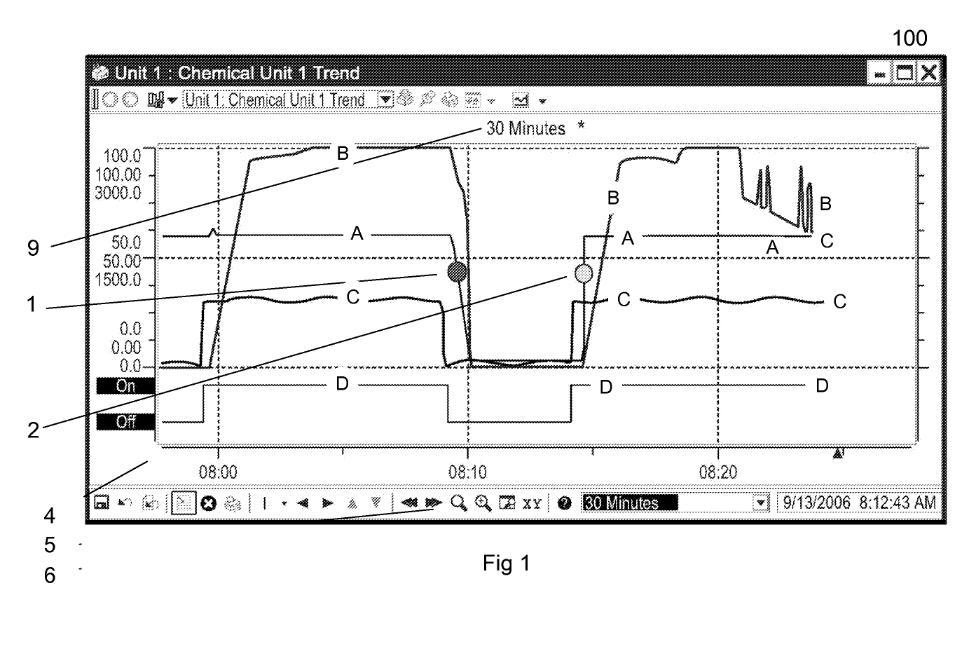

FIG. 1 shows a schematic diagram for an exemplary process display generated according to an aspect of the invention. The figure shows a display screen 100 displaying a trend chart with four trends or trend lines A-D. The process display is not limited to showing four trend lines and may be configured to display almost any number of trend lines which may be appropriate for controlling a given process. The time interval 9 of the trends and events shown on the display, 30 mins, is indicated on the screen display.

One of the trend lines, trend A, has been configured with settings for automatic indication of related events. As a result of this configuration, two events have been displayed and indicated visually on trend A. A first marker 1, shown on trend A in e.g. a first color, and a second marker 2, shown e.g. in a second color, are generated at positions on trend A corresponding to the time at which each of the two events occurred. In the example shown, trend A shows a drop in value between a time just before 08:10 to about just before 08:15. An operator who wishes to investigate the reason for this decrease does not need to search back and forth between the trend and event and alarm lists. Two events have been automatically selected and displayed (1, 2) on the trend curve in question as relevant to the variable that trend A represents. To obtain information about one or both of these events, the operator only needs to select, activate or interrogate the markers 1, and/or 2. It is understood that markers for different events may be represented with different colors, different shapes, as icons or other symbols on a graphic user interface and so on.

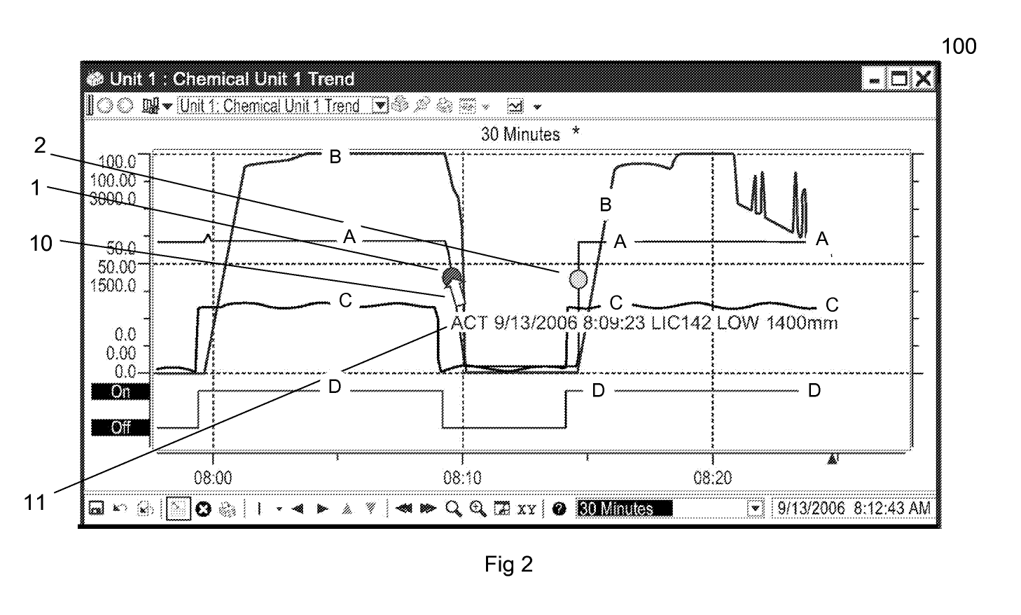

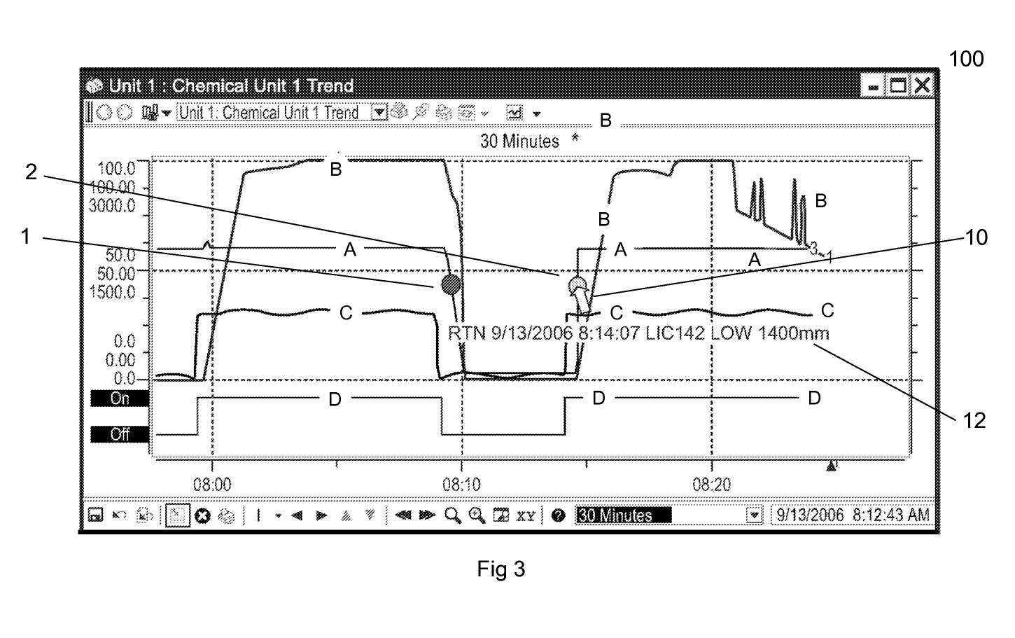

FIG. 2 shows generally the same display screen 100 as FIG. 1 with the exception that a position of a mouse pointer 10 is shown, and information in the form of a text line 11 is displayed. This diagram illustrates that when the operator positions a computer mouse (or operates another other input device) such that the pointer is over the first marker 1, then a display of information about the event indicated by the first marker is activated and the user can see the recorded information content of the event. This kind of display in other computer programs is sometimes called a Tool Tip, or possibly called a mouse-over or roll-over description. FIG. 3 shows generally the same display screen 100 as FIG. 2 with the exception that a position of a mouse pointer 10 is shown over the second marker 2 and other information about the second event in the form of a text line 12 is displayed.

The two events have been automatically selected as related or relevant to the variable represented by the trend line, on the basis of a pre-configuration. Process events are stored in the database 56. When searching for related process events, the database is scanned firstly for a configuration that an event is related to a given variable. Secondly the process Events found that are related may as well and/or instead be evaluated further on the basis of the time of the Event. Thus related events occurring within the time interval of a display may be selected first when generating a marker to be placed on a trend.

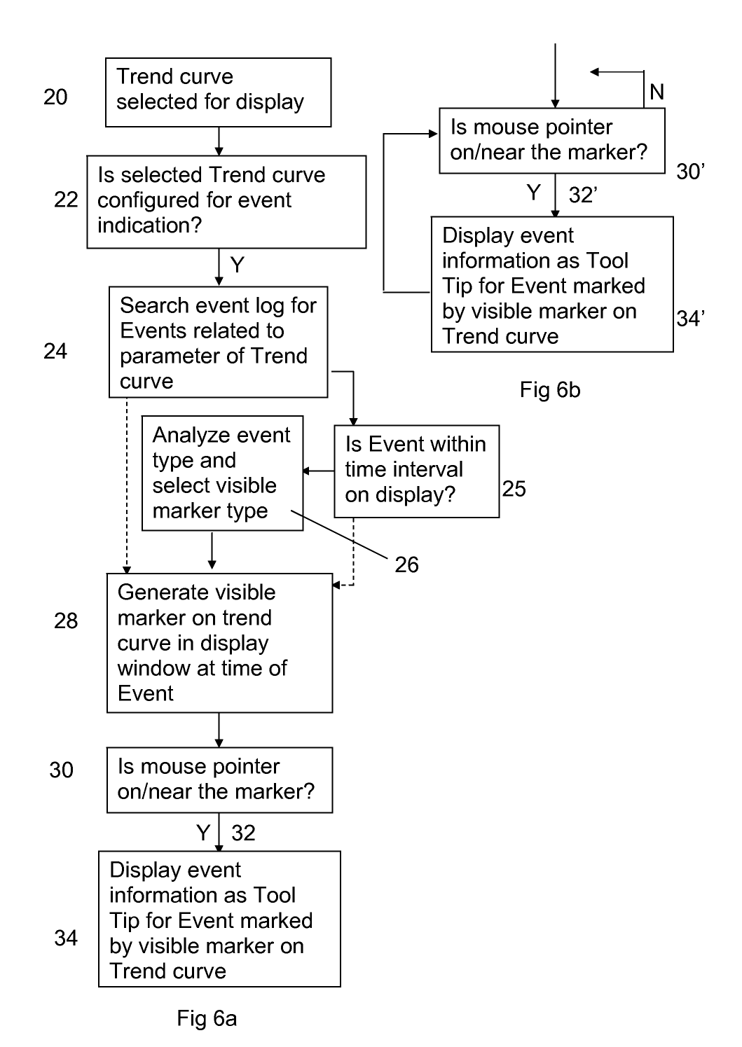

FIG. 6a shows a flowchart of a method according to an embodiment of the invention. The flowchart shows how a method according to an aspect of the invention may comprise the following steps:
20. Trend curve (FIG. 1, A-D) is selected for display.
22. Is selected Trend curve configured for event indication? In a configuration step, or by a predetermined selection, a trend curve may have been selected, e.g. marked with an indicator, for event indication as it may be important to a given trend of the process.
24. If yes, then Search the event log for Events related to the variable of the selected Trend curve, and
25. For any process Event related to the variable of the selected Trend curve that is found, determine time of Event, and if the time of the Event within a time interval displayed, then go to 26 or 28,
26. Analyze type of event and select type of visible marker, or else skip 26 and go straight to 28,
28. Generate visible marker on Trend curve in display window at time corresponding to the Event, with embedded link to Event data,
30. Is the mouse pointer on or close to a visible marker, if
32. Yes, then
34. Display event information for the corresponding Event marked on the Trend curve by the visible marker, e.g. as a Tool Tip.

Alternatively or as well a function that checks all the time to see if the mouse pointer is close to or on top of a visible marker may run. FIG. 6b shows a simple function, which may be the same as steps 30, 32, 34 of FIG. 6a, such as:
30′. Is the mouse pointer on or close to a visible marker,
32′. if Yes, then
34′. Display event information for the corresponding Event marked on the Trend curve by the visible marker, e.g. as a Tool Tip.

In other embodiments the selection of a marker, or activation of a marker, may be carried out by means of a touch screen. Users may also use movements of their hands instead of the pointing device or stylus to signal some of the commands. For example, a movement or an action by a user's hand on or close to the table or active display device surface may be determined by means of an inertial sensor.

One or more microprocessors (or processors or computers) comprise a central processing unit CPU performing the steps of the methods according to one or more aspects of the invention, as described for example with reference to FIGS. 1-3 and 6a, 6b. The method or methods are performed with the aid of one or more computer programs, which are stored at least in part in memory accessible by the one or more processors. It is to be understood that the computer programs for carrying out methods according to the invention may also be run on one or more general purpose industrial microprocessors or computers instead of one or more specially adapted computers or processors.

The computer program comprises computer program code elements or software code portions that make the computer or processor perform the methods using equations, algorithms, data, stored values, calculations and statistical or pattern recognition methods previously described, for example in relation to

FIGS. 6a, 6b. A part of the program may be stored in a processor as above, but also in a ROM, RAM, PROM, EPROM, or EEPROM chip or similar memory means. The or some of the programs in part or in whole may also be stored locally (or centrally) on a memory storage device and/or on a suitable computer readable medium such as a magnetic disk, CD-ROM or DVD disk, hard disk, magneto-optical memory storage means, in volatile memory, in flash memory, as firmware, or stored on one or more data servers. Other known and suitable media, including removable memory media such as a memory stick or other removable flash memories, hard drives etc. may also be used. The program may also in part be supplied from a data network, including a public network such as the Internet. The computer programs described may also be arranged in part as a distributed application capable of running on several different computers or computer systems at more or less the same time.

It should be noted that while the above describes exemplifying embodiments of the invention, there are several variations and modifications which may be made to the disclosed solution without departing from the scope of the present invention as defined in the appended claims.

1. A computer implemented method for displaying process information in an industrial control system including generating a trend curve for one or more variables of a process for a given time interval, and generating an event log, characterised in that the method further comprises generating at least one visible marker placed on the trend curve of a process information display and representing at least one event which is related to a variable that the trend curve represents.

2. The method according to claim 1, comprising the step of providing a display function associated with the at least one visible marker, which display function is activated when a user moves a visible pointer, hand or other indicator on the process information display on to, or close to, the visible marker placed on the trend curve.

3. The method according to claim 1, comprising the step of providing at least one visible marker comprising a link to the event or events related to the variable.

4. The method according to claim 1, comprising the step of providing a display function to automatically show event log information for the event or events related to the variable, which display function is activated when a user moves a computer selection or pointer device on to, or close to, the visible marker.

5. The method according to claim 4, comprising the step of displaying information about the event related to the variable on activation of the display function associated with the visible marker.

6. The method according to claim 1, comprising the step of generating the visible marker on the trend curve at the same time as the time of at least one event related to the variable that the trend curve represents.

7. The method according to claim 1, comprising the step of calculating which event or events are related to the variable that the trend curve represents and generating the visible marker on the trend curve at the same time as the time of the one or more events.

8. The method according to claim 1, comprising the step of calculating which event or events are related to the variable based in part on a look-up function to identify events configured to be related to a selected variable.

9. The method according to claim 1, comprising the step of calculating which event or events are related to the variable based in part on an automated cause-and-effect analysis.

10. The method according to claim 1, comprising the step of calculating which event or events are related to the variable based in part on experience information provided by operators after earlier occurrences.

11. The method according to claim 1, comprising the step of configuring in the industrial control system for one or more monitored variables for which a related event shall be marked on a trend curve with a visible marker.

12. The method according to claim 1 comprising the step of configuring an indicator in a control system such that a process in a workstation or a data server may identify one or more monitored variables for which a related event shall be marked on the trend curve.

13. The method according to claim 1, comprising the step of selecting a time interval for reporting event or events which are related to the variable that the trend curve represents and generating the visible marker on the trend curve at the time of the event when it is within the selected time interval.

14. The method according to claim 1, comprising the step of scanning the event log for events that are related to the variable that the trend curve represents and that also lie within a time interval that has been selected for the trend.

15. A computer program element comprising computer program code means which when read into a computer or processor will cause the computer or processor to carry out a method to display process information in an industrial control system according to claim 1.

16. A computer program embodied on a computer readable medium which when read into a computer or processor will cause the computer or processor to carry out one or more instructions for a method to display process information in an industrial control system using a computer program for control according to the steps of claim 1.

17. An industrial control system for displaying process information for a process, said system comprising a computer and a process information display device and a computer program for generating a trend curve for one or more variables of the process for a given time interval, characterised by said system further comprising a software and/or hardware device means for generating at least one visible marker placed on the trend curve and providing access to at least one event which is related to the variable that the trend curve represents.

18. The system according to claim 17, further comprising a software and/or hardware device for configuring a selected one or more monitored variables for which a related event shall be marked on the trend curve with a visible marker.

19. The system according to claim 17, further comprising software means for scanning a database, which database stores logged event data, for events that occurred in a selected time interval and are related to the selected one or more variables for which a related event shall be marked on the trend curve with a visible marker.

20. The system according to claim 17, further comprising a data server to provide and/or store logged event data for one or more selected variables for which a related event shall be marked on a trend curve.

21. The system according to claim 17, further comprising an input device for a graphical user interface for display of the process information.

22. The system according to claim 17 further comprising a process information display device arranged with a touch-sensitive screen and capable of selection input via the touch screen.

23. The system according to claim 21, further comprising a process information display device arranged with at least one sensor device for registering a close proximity of a hand or other object to a part of the display.

24. The system according to claim 21, further comprising a process information display device arranged with at least one sensor device for registering a movement or gesture of a hand or other object relative to a part of the display.

25. The system according to claim 17, wherein a process information display device of the system is arranged comprised in a portable computer device.

26. The system according to claim 17, wherein a computer program comprising computer readable program instructions or software code elements is stored in a memory storage device, which computer program when read into a computer or processor will cause the computer or processor to carry out a method to display process information in an industrial control system.

27. The system according to claim 26, wherein said system comprises a computer program memory storage device in or on which at least a part of the computer readable program instructions, software code elements or code means is stored.

28. Use of a system according to claim 15 for any from the list of: determining a status of a process, determining a status of a process variable, tuning a process, identifying a first event in a series of events, handling an alarm, closing an alarm, analyzing or determining the cause for a process up-set, analyzing or determining the cause for a deviation from normal or intended development of a process.

29. The system according to claim 26 wherein said computer program further generates an event log.
